(19) United States
(12) Patent Application Publication
(10) Pub. No.: US 2013/0005940 A1
(43) Pub. Date: Jan. 3, 2013

(54) POLYIMIDE NANOWEB

(75) Inventors: T. Joseph Dennes, Parkesburg, PA (US); Glen E. Simmonds, Avondale, PA (US); Pankaj Arora, Chesterfield, VA (US); Natalia V. Levit, Glen Allen, VA (US)

(73) Assignee: E I DU PONT DE NEMOURS AND COMPANY, Wilmington, DE (US)

(21) Appl. No.: 13/532,866

(22) Filed: Jun. 26, 2012

Related U.S. Application Data
(60) Provisional application No. 61/502,446, filed on Jun. 29, 2011.

(51) Int. Cl. C08G 73/10

(52) U.S. Cl. 528/353

(57) ABSTRACT

A nanoweb that contains a plurality of nanofibers wherein the nanofibers contain a fully aromatic polyimide that is characterized by having a crystallinity index (CI) and a degree of imidization (DOI). The product of the DOI and the CI is between 0.08 and 0.25 or above a lower limit to obtain a desired tensile strength and/or toughness. The nanoweb may for example have a tensile strength per unit basis weight of greater than 15 kg/cm² per gram per square meter unit of basis weight.

### FIELD OF THE INVENTION

This invention is directed to the manufacture of improved polyimide nanowebs with higher tensile strength and toughness properties than heretofore.

### BACKGROUND OF THE INVENTION

An important practical aspect of modern energy storage devices is ever-increasing energy density and power density. Safety has been found to be a major concern. Lithium ion cells currently in wide-spread commercial use are among the highest energy density batteries in common use and require multiple levels of safety devices, including external fuses and temperature sensors, that shut down a cell in case of overheating before a short circuit can occur as a result of the mechanical failure of the battery separator. Lithium-ion (Li-ion) batteries are also subject to explosion and fire should a short circuit occur because of mechanical or thermal failure of the separator.

Attempts have been made to produce battery separators from submicron fibers that combine strength with good electrical properties, for example Japanese Patent Application No. 2003-178406 (published as JP (Kokai) 2005-19026). The '406 application discloses polyimide separators with high tensile strength. However, high tensile strength fibers can be prone to have low toughness and are easy break or fracture, which can lead to short circuits in a battery. Tensile strength and toughness, which is a measure of the energy required to disrupt a web or membrane, do not necessarily correlate with each other and it is possible to produce a web of high tensile strength that does not have the ability to be formed into, or function as, an electrochemical cell. A need therefore remains for Li and Li-ion batteries prepared from materials that combine good electrochemical properties with good mechanical aspects such tensile strength and toughness.

### SUMMARY OF THE INVENTION

The present invention is directed to a nanoweb suitable for use as a battery separator, wherein the nanoweb comprises a plurality of polyimide nanofibers and has a tensile strength of at least 15 kg/cm² per gsm of basis weight, the polyimide also having a crystallinity index (CI) and a degree of imidization (DOI) such that the product of CI and DOI is at least 0.098, which corresponds to minimum toughness of the nanoweb at least 0.9 kg/cm² per gsm of basis weight.

The present invention is also directed to a nanoweb that comprises a plurality of nanofibers wherein the nanofibers comprise a polyimide that is characterized by having a crystallinity index (CI) and a degree of imidization (DOI), wherein the product of the DOI and the CI is at a value that is between limits that correspond to a nanoweb toughness per unit gsm of basis weight limit of greater or equal to 1.0 kg/cm² per gram per square meter unit of basis weight.

In one embodiment, the polyimide may be fully aromatic and may furthermore comprise monomer units derived from a compound selected from the group consisting of ODA, RODA, PDA, TDI, MDI, BTDA, PMDA, BPDA and any combination of the foregoing. When the polyimide comprises the monomer units PMDA and ODA or BPDA and RODA and the product of the DOI and the CI may be greater than 0.08.

The fully aromatic polyimide may further be characterized by having a crystallinity index (CI) and a degree of imidization (DOI), wherein the product of the DOI and the CI is between 0.08 and 0.25, or even above 0.1, or between 0.1 and 0.25.

The nanoweb may have a tensile strength per unit basis weight of greater than about 15 kg/cm² per gram per square meter unit of basis weight.

The present invention is also directed to a nanoweb that comprises a plurality of nanofibers wherein the nanofibers comprise a polyimide that is characterized by having a tensile strength per unit basis weight of greater than 8 kg/cm², or, 15 kg/cm² or even greater than 25 kg/cm² per gram per square meter unit of basis weight. In a still further embodiment the nanoweb has a toughness per unit basis weight of greater than about 0.5 kg/cm² per gram per square meter unit of basis weight.

In further embodiments the polyimide may have a product of the DOI and the CI between 0.08 and 0.25.

The invention is also directed to a multilayered article that comprises as one layer a nanoweb according to the description above. The multilayered article may also be directed to an electrochemical cell comprising a separator that further comprises a nanoweb according to the description above.

The invention is further directed to a nanoweb that comprises a plurality of nanofibers wherein the nanofibers comprise a fully aromatic polyimide that is made from the monomers PMDA and ODA, defined below, characterized by having a crystallinity index (CI) and a degree of imidization (DOI), wherein the product of the DOI and the CI is between 0.08 and 0.25 and wherein the nanoweb has a tensile strength per unit basis weight of greater than 8 kg/cm², or 15 kg/cm² or even greater than 25 kg/cm² per gram per square meter unit of basis weight or the nanoweb has a toughness per unit basis weight of greater than about 0.5 kg/cm² per gram per square meter unit of basis weight and wherein the nanoweb is made by a process that comprises the steps of; (i) preparing a nanoweb from polyamic acid, (ii) calendering the nanoweb of polyamic acid, and (iii) heating the calendered polyamic acid nanoweb in an oven, the interior of which is held at a temperature of between 200 and 500° C. for at least 5 seconds. The nanoweb of polyamic acid may also be heated before calendaring.

In another embodiment the invention is further directed to a nanoweb that comprises a plurality of nanofibers wherein the nanofibers comprise a fully aromatic polyimide that is made from the monomers PMDA and ODA, defined below, and characterized by having a crystallinity index (CI) and a degree of imidization (DOI), the product of the DOI and the CI is between 0.08 and 0.25 and wherein the nanoweb has a tensile strength per unit basis weight of greater than 8 kg/cm², or 15 kg/cm² or even 25 kg/cm² per gram per square meter unit of basis weight, or the nanoweb has a toughness per unit basis weight of greater than about 0.5 kg/cm² per gram per square meter unit of basis weight, and wherein the nanoweb is made by a process that comprises the steps of; (i) preparing a nanoweb from polyamic acid, (ii) heating the calendered polyamic acid nanoweb in an oven, the interior of which is held at a temperature of between 200 and 500° C. for at least 5 seconds and (iii) calendering the nanoweb of heated polyamic acid.

### BRIEF DESCRIPTION OF THE DRAWINGS

FIG. 1 shows tensile strength per gram per square meter unit of basis weight versus degree of imidization multiplied by crystallinity index for the specimens prepared in accordance with various embodiments of the present invention.

FIG. 2 shows the modulus of toughness per gram per square meter unit of basis weight versus degree of imidization multiplied by crystallinity index for the specimens prepared in accordance with various embodiments of the present invention.

### DESCRIPTION OF THE INVENTION

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

For the purposes of the present invention, the abbreviations and designations shown in Table 1, consistent with the practice in the polyimide art, will be employed:

TABLE 1

| Abbreviation | Chemical Name | Chemical Structure |
|---|---|---|
| PMDA | Pyromellitic Dianhydride | 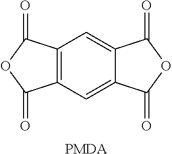 |
| BPDA | Biphenyltetracarboxylic Dianhydride | 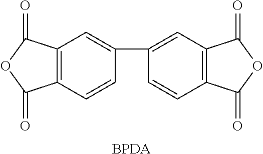 |
| ODA | Oxydianiline | 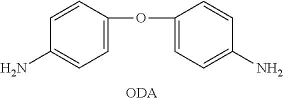 |
| RODA | 1,3-bis(4- aminophenoxy)benzene | 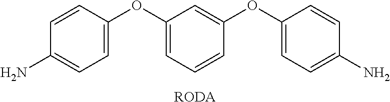 |
| PDA | 1,4 Phenylenediamine | 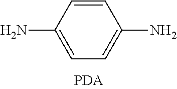 |
| TDI | 2,4-toluene diisocyanate and 2,6 toluene diisocyanate | 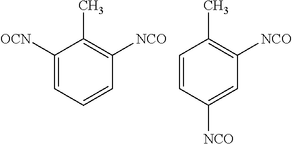 |
| MDI | Methylene diphenyl 4,4′-diisocyanate | 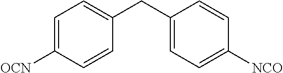 |
| BTDA | 3,3′,4,4′-benzophenone tetracarboxylic dianhydride | 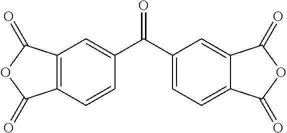 [SMILES: O=C(c1ccc2c(c1)C(=O)OC2=O)c1ccc2c(c1)C(=O)OC2=O] |

The compounds listed in table 1 are suitable for use in the present invention. Other dianhydrides and other diamines, not listed in Table 1, are also suitable for use in the present invention, with the proviso that suitable dianhydrides and diamines are consistent with the limitations described herein.

The term “nonwoven” means here a web including a multitude of randomly oriented fibers. By “randomly oriented” is meant that the fibers have no long range repeating structure discernable to the naked eye. The fibers can be bonded to each other, or can be unbonded and entangled to impart strength and integrity to the web. The fibers can be staple fibers or continuous fibers, and can comprise a single material or a multitude of materials, either as a combination of different fibers or as a combination of similar fibers each comprised of different materials.

The term “nanoweb” as applied to the present invention refers to a nonwoven web constructed predominantly of nanofibers. Predominantly means that greater than 50% of the fibers in the web are nanofibers, where the term “nanofibers” as used herein refers to fibers having a number average diameter less than 1000 nm, even less than 800 nm, even between about 50 nm and 500 nm, and even between about 100 and 400 nm. In the case of non-round cross-sectional nanofibers, the term “diameter” as used herein refers to the greatest cross-sectional dimension. The nanoweb of the invention can also have greater than 70%, or 90% or it can even contain 100% of nanofibers.

“Tensile strength” as used herein refers to the tensile strength of the nanoweb according to the test ISO 9073-3 and the “toughness” is calculated for each web sample as the area under the stress strain curve to break. Tensile strength and toughness refer to samples cut into 2″×10″ (5.08×25.4 cm) strips and pulled until breaking in a tensile testing machine at a rate of 5″/min (12.7 cm/min) with a gauge length of 8″ (20.32 cm)

The nanofibers employed in this invention consist essentially of one or more polyimides. Other components may be present in the nanofibers so long as the claimed properties of tensile strength, toughness and/or DOI*CI are present. For example, the nanofibers employed in this invention may be prepared from more than 80 wt % of one or more fully aromatic polyimides, more than 90 wt % of one or more fully aromatic polyimides, more than 95 wt % of one or more fully aromatic polyimides, more than 99 wt % of one or more fully aromatic polyimides, more than 99.9 wt % of one or more fully aromatic polyimides, or 100 wt % of one or more fully aromatic polyimides.

The “degree of imidization” (DOI) is defined herein as the ratio of the infra red IR absorbance of the imide C—N stretch (typically located at or near 1375 cm−1) to the absorbance of the aromatic C—H stretch (typically at or near 1500 cm−1). For any given monomer pair, the process for determining DOI involves the steps of running and IR spectrum and establishing the exact location of these absorbances.

The “crystallinity index” (CI) is defined as the ratio of the area under the crystalline peaks in the wide angle X ray diffraction spectrum (WAXD spectrum) to the area under the total function fit of the WAXD spectrum. WAXD peaks indicative of crystallinity for a given monomer combination are determined via comparison of several samples of widely varying levels of crystallinity.

The process of determining CI involves the step of running the WAXD spectra and determining which peaks are sufficiently sharp that they ought to be considered part of the crystalline phase of the polymer. Using this procedure, the absolute crystalline content of the sample is still unknown. However, the crystallinity index determined in this way allows comparison of the relative crystallinity of two polymers of the same polymer type (i.e. made with the same monomers.)

For CI determination, X-ray diffraction data are collected with a PANalytical X'Pert MPD with a Parabolic X-ray Mirror and Parallel Plate Collimator using Copper radiation. Samples for transmission geometry are prepared by stacking the thin films to a total thickness of approximately 0.7 mm. Data are collected from 3 to 45 degrees two-theta with a step size of 0.1 degree two-theta. Count time per data point is 10 seconds minimum with the sample rotating about the transmission axis at a rate of 0.1 revolutions per second.

A background is fitted to the baseline of the diffraction data. The background function is chosen to be a third order polynomial in the two-theta diffraction angle variable. The background subtracted data are then fit with a series of Gaussian peaks. A unique set of peaks must be determined for each polymer type of interest. This is done by comparing samples of widely varying crystallinity in order to determine the minimum number of broad (amorphous) and sharp (crystalline) peaks required, their position in two-theta, and their full width at half maximum. Peaks shown in Table 2 are obtained for PMDA-ODA polyimides. These peaks are fit to the background subtracted diffraction data using the solver least squares algorithm in Microsoft Excel®. Individual peak positions and widths are fixed. Amplitudes are refined as is an overall two-theta shift to correct for diffractometer two-theta error. Small adjustments to individual peak widths are allowed in a second refinement.

The ratio of the sum of the areas under the crystalline peaks to the total area under the fitted pattern is then expressed as a fraction and referred to as the crystallinity index for that sample. The diffraction peak near 6 degrees two-theta represents a form of polymer chain alignment that can be present even in largely amorphous samples. For this reason, the area represented by that peak is often reported separately to obtain a crystallinity index independent of that type of order.

The DOI multiplied by CI (denoted DOI*CI herein) is said to correspond to a given web toughness when the polyimide possesses a value of DOI*CI at that toughness. The web may have a given value of toughness at two values of DOI*CI. In one embodiment, the invention is a nanoweb that is characterized by having a value of DOI*CI between two values that correspond to a toughness as defined herein of 1.0 kg/cm² per gram per square meter unit of basis weight. The required limits of DOI multiplied by CI for a required nanoweb toughness or tensile strength are determined by the following process.

Polyamic acid nanowebs are prepared according to the process described herein, or some other process for assembling fibers into nanowebs. Samples are prepared with varying degrees of imidization and crystallinity by varying the temperature and length of time for which imidization is allowed to take place. For example and without wishing to limit the scope of the invention by theory, higher temperature and long time may tend to favor high degrees of imidization and crystallinity. Moderate temperatures may favor high degrees of imidization and lower crystallinity, and lower temperatures will favor low degrees of imidization and crystallinity.

Tensile strength and toughness are measured on the webs according to the procedures described herein and the toughness and tensile properties per unit basis weight of web are calculated. These are then plotted against the DOI*CI number obtained above. The required DOI*CI range or minimum value for a given toughness can then be obtained from such a plot, either visually or using a curve fitting algorithm. This value of DOI*CI is then said to “correspond to” a given toughness.

The article of the invention comprises a polyimide nanoweb and a separator manufactured form the nanoweb that exhibits desirably high strength and toughness. The invention further provides a multilayer article or an electrochemical cell that comprises the article of the invention, namely the polyimide nanoweb separator hereof as the separator between a first electrode material and a second electrode material.

Nanowebs may be fabricated by a process selected from the group consisting without limitation of electroblowing, electrospinning, and melt blowing. Electroblowing of polymer solutions to form a nanoweb is described in detail in Kim in World Patent Publication No. WO 03/080905, corresponding to U.S. patent application Ser. No. 10/477,882, incorporated herein by reference in its entirety. The electroblowing process in summary comprises the steps of feeding a polymer solution, which is dissolved into a given solvent, to a spinning nozzle; discharging the polymer solution via the spinning nozzle, which is applied with a high voltage, while injecting compressed air via the lower end of the spinning nozzle; and spinning the polymer solution on a grounded suction collector under the spinning nozzle.

The high voltage applied to the spinning nozzle can range from about 1 to 300 kV and the polymer solution can be compressively discharged through the spinning nozzle under a discharge pressure in the range of about 0.01 to 200 kg/cm².

The compressed air has a flow rate of about 10 to 10,000 m/min and a temperature of from about room temperature to 300° C.

Polyimide nanowebs suitable for use in this invention are prepared by imidization of a polyamic acid nanoweb where the polyamic acid is a condensation polymer prepared by reaction of one or more dianhydride and one or more diamine. The term “fully aromatic” when applied to polyimide or polyamic acid means that the monomers from which the polyamic acid are produced are aromatic. Suitable aromatic dianhydrides include but are not limited to pyromellitic dianhydride (PMDA), biphenyltetracarboxylic dianhydride (BPDA), and mixtures thereof. Suitable diamines include but are not limited to oxydianiline (ODA), 1,3-bis(4-aminophenoxy)benzene (RODA), and mixtures thereof. Preferred dianhydrides include pyromellitic dianhydride, biphenyltetracarboxylic dianhydride, and mixtures thereof. Preferred diamines include oxydianiline, 1,3-bis(4-aminophenoxy)benzene and mixtures thereof. Most preferred are PMDA and ODA.

In the polyamic acid nanoweb imidization process hereof, the polyamic acid is first prepared in solution; typical solvents are dimethylacetamide (DMAC) or dimethyformamide (DMF). In one method suitable for the practice of the invention, the solution of polyamic acid is formed into a nanoweb by electroblowing, as described in detail by Kim et al. in World Patent Publication No. WO 03/080905.

The polyamic acid nanoweb may optionally be calendered. “Calendering” is the process of passing a web through a nip between two rolls. The rolls may be in contact with each other, or there may be a fixed or variable gap between the roll surfaces. Advantageously, in the present calendering process, the nip is formed between a soft roll and a hard roll. The “soft roll” is a roll that deforms under the pressure applied to keep two rolls in a calender together. The “hard roll” is a roll with a surface in which no deformation that has a significant effect on the process or product occurs under the pressure of the process. An “unpatterned” roll is one which has a smooth surface within the capability of the process used to manufacture them. There are no points or patterns to deliberately produce a pattern on the web as it passed through the nip, unlike a point bonding roll. The calendaring process may also use two hard rolls.

Imidization of the polyamic acid nanoweb so formed may conveniently be performed by first subjecting the nanoweb to solvent extraction at a temperature of ca. 100° C. in a vacuum oven with a nitrogen purge; following extraction, the oven is then heated to a temperature of 200 to 500° C. such that the nanoweb is heated thereby for at least 5 seconds, or about 10 minutes or less, preferably 5 minutes or less, more preferably 2 minutes or less, and even more preferably 1 minute or even 30 seconds or less, to sufficiently imidize the nanoweb. Preferably the imidization process comprises heating the polyamic acid (PAA) nanoweb to a temperature in the range of a first temperature and a second temperature for a period of time in the range of 5 seconds to 5 minutes to form a polyimide fiber, wherein the first temperature is the imidization temperature of the polyamic acid and the second temperature is the decomposition temperature of the polyimide.

The process hereof may furthermore comprise heating the polyamic acid fiber so obtained, to a temperature in the range of a first temperature and a second temperature for a period of time in the range of 5 seconds to 5 minutes to form a polyimide fiber or from 5 seconds to 4 minutes or from 5 seconds to 3 minutes, or from 5 seconds to 30 seconds. The first temperature is the imidization temperature of the polyamic acid. For the purposes of the present invention, the imidization temperature for a given polyamic acid fiber is the temperature below 500° C. at which in thermogravimetric (TGA) analysis performed at a heating rate of 50° C./min, the % weight loss/° C. decreases to below 1.0, preferably below 0.5 with a precision of ±0.005% in weight % and ±0.05° C. The second temperature is the decomposition temperature of the polyimide fiber formed from the given polyamic acid fiber. Furthermore, for the purposes of the present invention, the decomposition temperature of the polyimide fiber is the temperature above the imidization temperature at which in thermogravimetric (TGA), the % weight loss/° C. increases to above 1.0, preferably above 0.5 with a precision of ±0.005% in weight % and ±0.05° C.

The invention is therefore directed in one embodiment to a nanoweb that comprises a plurality of nanofibers wherein the nanofibers comprise a fully aromatic polyimide that is characterized by having a crystallinity index (CI) and a degree of imidization (DOI), and wherein the nanoweb has a toughness per unit basis weight of greater than 1 kg/cm² per gram per square meter unit of basis weight and wherein the nanoweb is made by a process that comprises the steps of; (i) preparing a nanoweb from polyamic acid, (ii) calendering the nanoweb of polyamic acid, and (iii) heating the polyamic acid for at least 5 seconds in an oven held at a temperature of between 200 and 500° C.

In a further embodiment the invention is directed to a nanoweb that comprises a plurality of nanofibers wherein the nanofibers comprise a fully aromatic polyimide that is characterized by having a crystallinity index (CI) and a degree of imidization (DOI), and wherein the nanoweb has a toughness per unit basis weight of greater than 1 kg/cm² per gram per square meter unit of basis weight and wherein the nanoweb is made by a process that comprises the steps of; (i) preparing a nanoweb from polyamic acid, (ii) heating the polyamic acid nanoweb for at least 5 seconds in an oven held at a temperature of between 200 and 500° C., and (iii) calendering the nanoweb of heated polyamic acid.

In one method suitable for the practice of invention, a polyamic acid fiber is pre-heated at a temperature in the range of room temperature and the imidization temperature before the step of heating the polyamic acid fiber at a temperature in the range of the imidization temperature and the decomposition temperature. This additional step of pre-heating below the imidization temperature allows slow removal of the residual solvent present in the polyamic acid fiber and prevents the possibility of flash fire due to sudden removal and high concentration of solvent vapor if heated at or above the imidization temperature.

The step of thermal conversion of the polyamic acid fiber to the polyimide fiber can be performed using any suitable technique, such as, heating in a convection oven, vacuum oven, infra-red oven in air or in inert atmosphere such as argon or nitrogen. A suitable oven can be set at a single temperature or can have multiple temperature zones, with each zone set at a different temperature. In an embodiment, the heating can be done step wise as done in a batch process. In another embodiment, the heating can be done in a continuous process, where the sample can experience a temperature gradient.

In one embodiment, the polyamic acid fiber is heated in a multi-zone infra-red oven with each zone set to a different temperature. In an alternative embodiment, all the zones are set to the same temperature. In another embodiment the infrared oven further comprises an infra-red heater above and below a conveyor belt. In a further embodiment of the infrared oven suitable for use in the invention, each temperature zone is set to a temperature in the range of room temperature and a fourth temperature, the fourth temperature being 150° C. above the second temperature. It should be noted that the temperature of each zone is determined by the particular polyamic acid, time of exposure, fiber diameter, emitter to emitter distance, residual solvent content, purge air temperature and flow, fiber web basis weight (basis weight is the weight of the material in grams per square meter). For example, conventional annealing range is 400-500° C. for PMDA/ODA, but is around 200° C. for BPDA/RODA. Also, one can shorten the exposure time, but increase the temperature of the infra-red oven and vice versa. In one embodiment, the fiber web is carried through the oven on a conveyor belt and goes though each zone for a total time in the range of 5 seconds to 5 minutes, set by the speed of the conveyor belt. In another embodiment, the fiber web is not supported by a conveyor belt.

Polyimides are typically referred to by the names of the condensation reactants that form the monomer unit. That practice will be followed herein. Thus, the polyimide formed from the monomer units: pyromellitic dianhydride (PMDA) and oxy-dianiline (ODA) and represented by the structure below is designated PMDA/ODA.

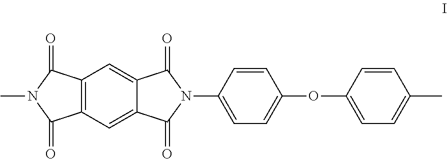

In one embodiment, the polyimide nanoweb consists essentially of polyimide nanofibers formed from the monomer units: pyromellitic dianhydride (PMDA) and oxy-dianiline (ODA), having monomer units represented by the structure (I).

In another embodiment, the polyimide fiber of this invention comprises more than 80 weight % of one or more fully aromatic polyimides, more than 90 weight % of one or more fully aromatic polyimides, more than 95 weight % of one or more fully aromatic polyimides, more than 99 weight % of one or more fully aromatic polyimides, more than 99.9 weight % of one or more fully aromatic polyimides, or 100 weight % of one or more fully aromatic polyimides. As used herein, the term “fully aromatic polyimide” refers specifically to polyimides in which the ratio of the imide C—N infrared absorbance at 1375 cm⁻¹ to the p-substituted C—H infrared absorbance at 1500 cm⁻¹ is greater than 0.51 and wherein at least 95% of the linkages between adjacent phenyl rings in the polymer backbone are effected either by a covalent bond or an ether linkage. Up to 25%, preferably up to 20%, most preferably up to 10%, of the linkages can be effected by aliphatic carbon, sulfide, sulfone, phosphide, or phosphone functionalities or a combination thereof. Up to 5% of the aromatic rings making up the polymer backbone can have ring substituents of aliphatic carbon, sulfide, sulfone, phosphide, or phosphone. Preferably the fully aromatic polyimide suitable for use in the present contains no aliphatic carbon, sulfide, sulfone, phosphide, or phosphone.

In one embodiment, the present invention is directed to a nanoweb that comprises a plurality of nanofibers wherein the nanofibers comprise a fully aromatic polyimide made from PMDA and ODA monomers that is characterized by having a crystallinity index (CI) and a degree of imidization (DOI). The product of the DOI and the CI is greater than 0.08, or between 0.08 and 0.25. In a further embodiment, the nanoweb has a product of the DOI and the CI is between 0.1 and 0.25.

The polyimide may further comprise the monomer units PMDA and ODA or BPDA and RODA and the product of the DOI and the CI is greater than 0.08.

In further embodiments the nanoweb may be made from any combination of monomers and have a tensile strength per unit basis weight of greater than 8 kg/cm², or 15 kg/cm² or even 25 kg/cm² per gram per square meter unit of basis weight or wherein the nanoweb has a toughness per unit basis weight of greater than about 0.5 kg/cm² or even 1.0 kg/cm² per gram per square meter unit of basis weight as measured by the methods described below in the “Examples” section.

The nanoweb of the invention may further be made by a process that comprises the steps of; (i) preparing a nanoweb from polyamic acid, (ii) calendaring the nanoweb of polyamic acid, and (iii) heating the calendered polyamic acid nanoweb in an oven that is maintained at one or more temperatures of between 200 and 500° C. for at least 5 seconds or even 30 seconds.

The heating step (iii), above, may also be carried out in an oven that is held at between 250 and 500° C., or 300 and 500° C., or even 350 and 500° C., or even 300 and 450° C.

In one aspect, the invention provides a multi-layer article comprising a first electrode material, a second electrode material, and a porous separator disposed between and in contact with the first and the second electrode materials, wherein the porous separator comprises a nanoweb that includes a plurality of nanofibers wherein the nanofibers are in the form of any embodiment of the fully aromatic polyimide nanoweb of the present invention. In one embodiment of the multi-layer article, the first and second electrode materials are different, and the multi-layer hereof is useful in batteries. In an alternative embodiment, the first and second electrode materials are the same, and the multi-layer article hereof is useful in capacitors, particularly in that class of capacitors known as “electrochemical double layer capacitors.”

In one embodiment, the first electrode material, the separator, and the second electrode material are in mutually adhering contact in the form of a laminate. In one embodiment the electrode materials are combined with polymers and other additives to form pastes that are applied to the opposing surfaces of the nanoweb separator. Pressure and/or heat can be applied to form an adhering laminate.

In one embodiment wherein the multi-layer article of the invention is useful in lithium ion batteries, a negative electrode material comprises an intercalating material for Li ions, such as carbon, preferably graphite, coke, lithium titanates, Li—Sn Alloys, Si, C—Si Composites, or mixtures thereof; and a positive electrode material comprises lithium cobalt oxide, lithium iron phosphate, lithium nickel oxide, lithium manganese phosphate, lithium cobalt phosphate, MNC (LiMn(⅓)Co(⅓)Ni(⅓)O₂), NCA (Li(Ni_{1-y-z}Co_{y}Al_{z})O₂), lithium manganese oxide, or mixtures thereof.

In one embodiment the multi-layer article hereof further comprises at least one metallic current collector in adhering contact with at least one of the first or second electrode materials. Preferably the multi-layer article hereof further comprises a metallic current collector in adhering contact with each the electrode material.

In another aspect, the invention provides an electrochemical cell comprising a housing having disposed therewithin, an electrolyte, and a multi-layer article at least partially immersed in the electrolyte; the multi-layer article comprising a first metallic current collector, a first electrode material in electrically conductive contact with the first metallic current collector, a second electrode material in ionically conductive contact with the first electrode material, a porous separator disposed between and contacting the first electrode material and the second electrode material; and, a second metallic current collector in electrically conductive contact with the second electrode material, wherein the porous separator comprises a nanoweb that includes a plurality of nanofibers wherein the nanofibers are in the form of any embodiment of the fully aromatic polyimide nanoweb of the present invention. Ionically conductive components and materials transport ions, and electrically conductive components and materials transport electrons.

In one embodiment of the electrochemical cell hereof, the first and second electrode materials are different, and the electrochemical cell hereof is a battery, preferably a lithium ion battery. In an alternative embodiment of the electrochemical cell hereof the first and second electrode materials are the same and the electrochemical cell hereof is a capacitor, preferably an electrochemical double layer capacitor. When it is stated herein that the electrode materials are the same it is meant that they comprise the same chemical composition, however, they may differ in some structural component such as thickness, density, particle size etc.

In a further embodiment of the multi-layer article of the invention, at least one electrode material is coated onto a non-porous metallic sheet that serves as a current collector. In a preferred embodiment, both electrode materials are so coated. In the battery embodiments of the electrochemical cell hereof, the metallic current collectors comprise different metals. In the capacitor embodiments of the electrochemical cell hereof, the metallic current collectors comprise the same metal. The metallic current collectors suitable for use in the present invention are preferably metal foils.

In one embodiment, a PMDA/ODA amic acid nanoweb produced by condensation polymerization from solution followed by electroblowing of the nanoweb, is first heated to ca. 100° C. in a vacuum oven with a nitrogen purge to remove residual solvent. Following solvent removal, the oven is heated to a temperature in the range of 100-350° C. and the nanoweb held for a period of less than 15 minutes, preferably less than 10 minutes, more preferably less than 5 minutes, most preferably less than 30 seconds until at least 90% of the amic acid functionality has been converted (imidized) to imide functionality, preferably until 100% of the amic acid functionality has been imidized. The thus imidized nanoweb is preferably then heated to a temperature in the range of 400-500° C., more preferably in the range of 400-450° C., for a period of 5 seconds to 20 minutes.

In another aspect, the invention provides an electrochemical double layer capacitor (EDLC). EDLCs are energy storage devices having a capacitance that can be as high as several Farads. Charge storage in double-layer electrochemical capacitors is a surface phenomenon that occurs at the interface between the electrodes, typically carbon, and the electrolyte. In double layer capacitors, the separator absorbs and retains the electrolyte thereby maintaining close contact between the electrolyte and the electrodes. The role of the separator is to electrically insulate the positive electrode from the negative electrode and to facilitate the transfer of ions in the electrolyte, during charging and discharging. Electrochemical double layer capacitors are typically made in a cylindrically wound design in which the two carbon electrodes and separators are wound together, separators having high strength are desired to avoid short-circuits between the two electrodes.

### EXAMPLES

### Test Methods

### Crystallinity Index Method

The parameter “crystallinity index” (CI) as employed herein refers to a relative crystallinity parameter determined from Wide-Angle X-ray Diffraction (WAXD). X-ray diffraction data were collected with a PANalytical X'Pert MPD equipped with a Parabolic X-ray Mirror and Parallel Plate Collimator using Copper radiation. Samples for transmission geometry were prepared by stacking the thin films to a total thickness of approximately 0.7 mm. Data were collected over a range of two-theta of 3 to 45 degrees with a step size of 0.1 degree. Count time per data point was 10 seconds minimum with the sample rotating about the transmission axis at a rate of 0.1 revolutions per second.

The WAXD scan so generated consisted of three contributions: 1) a background signal; 2) scattering from ordered but amorphous regions; 3) scattering from crystalline regions. A polynomial background was fitted to the baseline of the diffraction data. The background function was chosen to be a third order polynomial in the two-theta diffraction angle variable. The background subtracted data was then least squares fitted with a series of Gaussian peaks which represented either ordered amorphous or crystalline components. The ratio of the integral under the crystalline peaks so selected, to the integral under the overall scan curve with the background subtracted was the crystallinity index.

Peaks shown in Table 2 were obtained for PMDA-ODA polyimides.

TABLE 2
WAXD (Two-theta degrees)
11.496
15.059
16.828
22.309

### Determination of Degree of Imidization (DOI)

The infrared spectrum of a given sample was measured, and the ratio of the imide C—N absorbance at 1375 cm⁻¹ to the p-substituted C—H absorbance at 1500 cm⁻¹ was calculated. This ratio was taken as the degree of imidization (DOI).

The polyimide nanowebs hereof were analyzed by ATR-IR using a DuraSampl/R (ASI Applied Systems) accessory on a Nicolet Magna 560 FTIR (ThermoFisher Scientific). Spectra were collected from 4000-600 cm−1 and were corrected for the ATR effect (depth of penetration versus frequency).

### Fiber Size Determination

Nanofiber diameter was determined using the following method.

1. One or more SEM (Scanning Electron Microscope) images were taken of the nanoweb surface at a magnification that included 20-60 measurable fibers.

2. Three positions on each image were selected which appeared by visual inspection to represent the average appearance of the nanoweb.

3. Image analysis software was used to measure the fiber diameter of 60 to 180 fibers and calculate the mean from the selected areas.

### ODA/PMDA Samples

The process and the product of the invention will now be demonstrated with regard to polyimide nanowebs made from ODA/PMDA.

### Polymer Preparation

### Poly(Amic Acid) Solution (PAA)

33.99kg of PMDA (DuPont Mitsubishi Gas Ltd.) was combined in a 100 Gallon stirred stainless steel reactor with 32.19 kg of 4,4 ODA (Wakayama Seika) and 1.43 kg of phthalic anhydride (Aldrich Chemical) in 215.51 kg of DMF (DuPont). They were mixed and reacted while stirring at room temperature for 30 hours to form polyamic acid by first adding the ODA to the DMF, then adding the PMDA and finally adding the phthalic anhydride. The resulting polyamic acid had a room temperature solution viscosity of 58 poise.

### Nanoweb Preparation

Nanowebs were prepared from the poly(amic acid) solutions prepared supra by electroblowing, is described in detail in U.S. Published Patent Application 2005/0067732.

### Nanoweb

PAA solution was electroblown according to the process described in U.S. patent application publication number 2005/0067732, hereby incorporated herein in its entirety by reference, with the solution being discharged from the spinning nozzle at a temperature of 37° C. The electroblown nanoweb had a basis weight of 18 grams per square meter (gsm) and was then calendered at room temperature between a hard steel roll and a cotton covered roll at 1800 pounds per linear inch (32.2 kg per linear centimeter) on a BF Perkins calender.

Following the preparation of the nanoweb, the dried and calendered, but not yet imidized, nanoweb specimens of PAA nanofibers were cut into sheets of approximately 8″ width by 12″ length and then heated by placing the sample on a metal tray lined with Kapton® film and then placing the tray with the sample on it in a laboratory convection oven that had been preheated to temperatures ranging from 200° C. to 540° C. for 2 minutes. The mean fiber diameter from the sample heated in an oven that had been held at 400° C. for 2 minutes was 805 nm and the porosity was 52.2%. The sample with no additional heating had a mean fiber diameter of 851 nm and a porosity of 53.1%

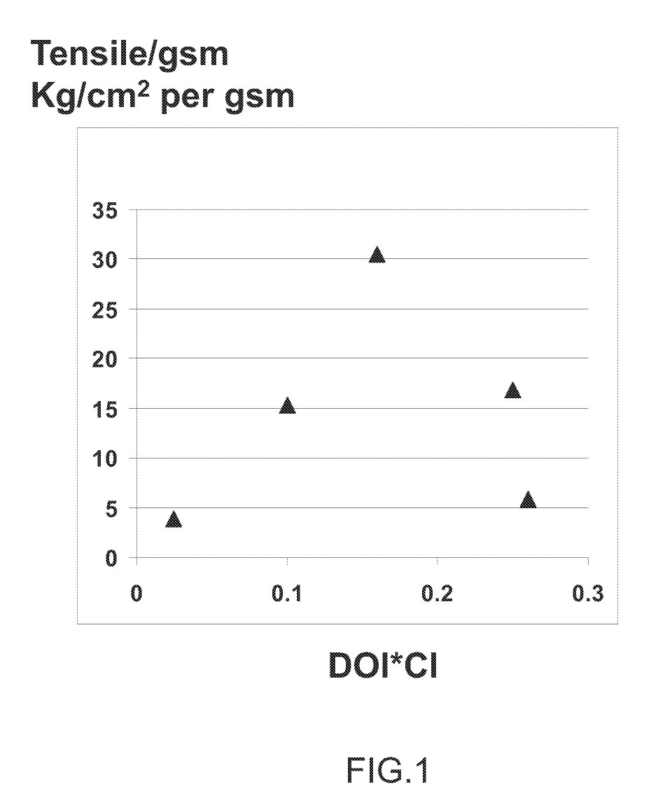

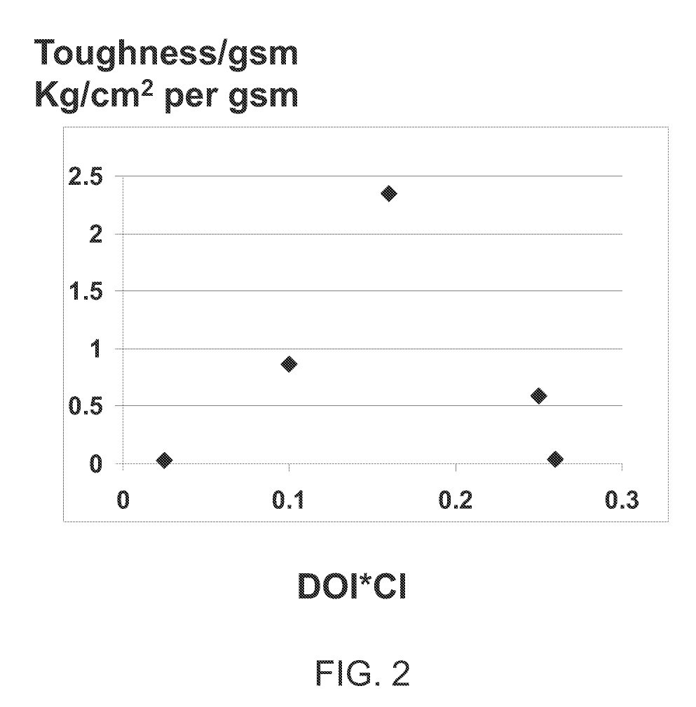

Degree of imidization (DOI), crystallinity index (CI), tensile strength (according to ISO 9073-3;), and elongation at break were measured and the toughness was calculated for each sample as the area under the stress strain curve to break. Samples were cut into 2″×10″ (5.08×25.4 cm) strips and pulled until breaking in an Instron machine at a rate of 5″/min (12.7 cm/min) with a gauge length of 8″ (20.32 cm). Results are shown in Table 3 and depicted graphically in FIGS. 1-2.

TABLE 3

| | Elon- | Tensile | | | | |
|---|---|---|---|---|---|---|
| | gation | Strength | Toughness | DOI, | Crystal- | |
| | at Break | (kg/cm²) | (kg/cm²) | IR Peak | linity | |
| Example | (%) | per gsm | per gsm | Ratio | Index (CI) | DOI *CI |
| 1 | 1.7 | 3.87 | 0.49 | 0.357 | 0.07 | 0.025 |
| 2 | 8.9 | 15.27 | 0.86 | 0.550 | 0.18 | 0.10 |
| 3 | 14.5 | 30.52 | 2.35 | 0.533 | 0.30 | 0.16 |
| 4 | 6.2 | 16.83 | 0.59 | 0.541 | 0.47 | 0.25 |
| 5 | 1.4 | 5.87 | 0.04 | 0.569 | 0.46 | 0.26 |

The superior tensile strength that is obtained with a sufficiently high degree of imidization simultaneously with moderately high crystallinity index is shown in table 3. In FIG. 1 is plotted the tensile strength per unit basis weight of the samples against the product of CI and DOI. The data show that either DOI or CI or both can be sufficiently high to produce a superior (high) tensile strength. In FIG. 2 is plotted toughness as a function of the product of CI and DOI. When the product of DOI and CI is between 0.1 and 0.25, the nanoweb exhibits high tensile strength and high modulus of toughness, which are necessary for battery and capacitor manufacturing. It should be noted that toughness and tensile strength do not correlate. A web may have a relatively high tensile strength and low toughness, for example at higher values of DOI*CI, and therefore toughness is not inherent to high tensile strength webs.

The data were further fitted to cubic polynomials with the following results.

Tensile (kg/cm2) per unit basis weight (gsm)=−15946x³+5346x²−304x+8.4 with an R squared of 0.943.

Toughness (kg/cm2) per unit basis weight (gsm)=−28383x³+9675x²−619.3x+10.2 with an R squared of 0.9973.

Where x is the DOI*CI. Although the data fit is not intended to be limiting in any way to the present claims, certain embodiments of the invention which therefore correspond to certain values of toughness and tensile strength based on the model fit are disclosed and given in tables 4 and 5 below, in which the values of DOI*CI for each embodiment may lie between the given values or at the end points of the ranges given. The value of DOI*CI may also be limited to being only above the lower limit of DOI that corresponds to a certain desired value of toughness, tensile strength or both.

TABLE 4

| Toughness | DOI * CI | DOI * CI |
|---|---|---|
| Kg/cm² per gsm | Lower Limit | Upper Limit |
| 0.5 | 0.0825 | 0.256 |
| 0.8 | 0.095 | 0.252 |
| 1.0 | 0.103 | 0.249 |
| 1.5 | 0.122 | 0.239 |
| 2.0 | 0.142 | 0.227 |

TABLE 5

| Tensile Strength | DOI * CI | DOI * CI |
|---|---|---|
| Kg/cm² per gsm | Lower Limit | Upper Limit |
| 5 | 0.053 | No limit |
| 10 | 0.08 | No limit |
| 15 | 0.098 | 0.254 |
| 20 | 0.115 | 0.246 |
| 25 | 0.133 | 0.236 |
| 30 | 0.153 | 0.222 |

We claim:

1. A nanoweb that comprises a plurality of nanofibers wherein the nanofibers comprise a polyimide and the nanoweb has toughness per unit gsm of basis weight limit of greater than or equal to 1.0 kg/cm² per gram per square meter unit of basis weight.

2. The nanoweb of claim 1 wherein the polyimide is characterized by having a crystallinity index (CI) and a degree of imidization (DOI), wherein the product of the DOI and the CI is at a value that is between two values that correspond to a nanoweb toughness per unit gsm of basis weight limit of greater or equal to 1.0 kg/cm² per gram per square meter unit of basis weight.

3. The nanoweb of claim 1 in which the polyimide is fully aromatic.

4. The nanoweb of claim 3 wherein the polyimide comprises monomer units derived from a compound selected from the group consisting of ODA, RODA, PDA, TDI, MDI, BTDA, PMDA, BPDA and any combination of the foregoing.

5. The nanoweb of claim 4 in which the polyimide comprises the monomer units PMDA and ODA or BPDA and RODA and the product of the DOI and the CI is greater than 0.08.

6. The nanoweb of claim 5 wherein the nanofibers comprise a polyimide that is characterized by having a crystallinity index (CI) and a degree of imidization (DOI), wherein the product of the DOI and the CI is between 0.08 and 0.25.

7. The nanoweb of claim 5 wherein the product of the DOI and the CI is above 0.1.

8. The nanoweb of claim 1 wherein the nanoweb has a tensile strength per unit basis weight of greater than about 15 kg/cm² per gram per square meter unit of basis weight.

9. A multi-layer article in which at least one layer comprises the nanoweb of claim 1.

10. An electrochemical cell comprising the nanoweb of claim 1.

11. A nanoweb that comprises a plurality of nanofibers wherein the nanofibers comprise a fully aromatic polyimide that is characterized by having a crystallinity index (CI) and a degree of imidization (DOI), and wherein the nanoweb has a toughness per unit basis weight of greater than 1 kg/cm² per gram per square meter unit of basis weight and wherein the nanoweb is made by a process that comprises the steps of; (i) preparing a nanoweb from polyamic acid, (ii) calendering the nanoweb of polyamic acid, and (iii) heating the polyamic acid for at least 5 seconds in an oven, the interior of which is held at a temperature of between 200 and 500° C.

12. A nanoweb that comprises a plurality of nanofibers wherein the nanofibers comprise a fully aromatic polyimide that is characterized by having a crystallinity index (CI) and a degree of imidization (DOI), and wherein the nanoweb has a toughness per unit basis weight of greater than 1 kg/cm² per gram per square meter unit of basis weight and wherein the nanoweb is made by a process that comprises the steps of; (i) preparing a nanoweb from polyamic acid, (ii) heating the polyamic acid nanoweb for at least 5 seconds in an oven, the interior of which is held at a temperature of between 200 and 500° C., and (iii) calendering the nanoweb of heated polyamic acid.

13. A nanoweb comprising a plurality of polyimide nanofibers having a tensile strength of at least 15 kg/cm² per gsm of basis weight, the polyimide also having a crystallinity index (CI) and a degree of imidization (DOI) such that the product of CI and DOI is at least 0.098, which corresponds to minimum toughness of the nanoweb at least 0.9 kg/cm² per gsm of basis weight.
